(19) United States
(12) Patent Application Publication
(10) Pub. No.: US 2016/0309227 A1
(43) Pub. Date: Oct. 20, 2016

(54) REAL-TIME RECORDING TIMER ADJUSTMENTS AND RELATED METHODS, DEVICES AND SYSTEMS

(71) Applicant: ECHOSTAR TECHNOLOGIES L.L.C., Englewood, CO (US)

(72) Inventor: Steven Michael Casagrande, Castle Rock, CO (US)

(21) Appl. No.: 14/691,347

(22) Filed: Apr. 20, 2015

(51) Int. Cl. H04N 21/458; H04N 21/4147; H04N 21/433

(52) U.S. Cl. CPC H04N 21/4583; H04N 21/4334; H04N 21/4147

(57) ABSTRACT

Methods, devices and systems are provided for recording a broadcast media program using a media device. An exemplary method involves receiving audiovisual content for the broadcast media program from a distribution network and receiving via the distribution network, an indication to adjust a recording timer associated with the broadcast media program scheduled for recording in accordance with a broadcast schedule. In response to the indication, a recording timer associated with the broadcast media program is automatically adjusted to deviate from the broadcast schedule, and the audiovisual content is automatically recorded in accordance with the adjusted recording timer.

### TECHNICAL FIELD

The following description generally relates to reconfiguring media device recording timers in real-time.

### BACKGROUND

Media content can now be received from any number of different sources and stored in a personal or digital video recorder (DVR) or the like for viewing at a later time (“time shifting”). Many media devices equipped with DVR functionality are configurable to schedule recordings of broadcast media program in advance of airing according to a predetermined broadcast schedule. However, in some situations, changes in the broadcast schedule after the recording is scheduled or initiated can impair the ability of the media device to record the entirety of the desired broadcast media program, which is often frustrating to users. For example, the duration of a real-time event may exceed the expected duration according to the broadcast schedule, which, in turn, can delay the actual end time of the broadcast media program corresponding to the real-time event and/or delay the start time of media programs following the broadcast media program in the broadcast schedule. Accordingly, it is desirable to account for deviations in the content being broadcasted relative to the predetermined broadcast schedule in a manner that enhances the user experience. Other desirable features and characteristics may also become apparent from the subsequent detailed description and the appended claims, taken in conjunction with the accompanying drawings and this background section.

### BRIEF SUMMARY

According to various exemplary embodiments, systems, devices and methods are provided for recording a broadcast media program. One exemplary method of recording using a media device receiving the audiovisual content for a broadcast media program from a network involves the media device receiving, via the network, an indication to adjust a recording timer associated with the broadcast media program scheduled for recording in accordance with a broadcast schedule. In response to the indication, the media device automatically adjusts the recording timer associated with the broadcast media program to deviate from the broadcast schedule and automatically records the audiovisual content according to the adjusted recording timer.

Another embodiment of a recording content corresponding to a broadcast media program using a media device including a receiver arrangement configured to receive the content from a distribution network involves initiating recording of the content corresponding to the broadcast media program from the receiver arrangement to a storage element of the media device in accordance with a broadcast schedule. The method continues by receiving, by the media device via the distribution network, an indication to extend recording of the broadcast media program, and in response to the indication, extending the recording of the content received via the receiver arrangement for a duration of time beyond an end time for the broadcast media program specified by the broadcast schedule.

An embodiment of a media device is also provided. The media device includes a receiver arrangement to receive content corresponding to a broadcast media program from a broadcast channel of a distribution network, a storage element, and a control module coupled to the receiver arrangement and the storage element. The control module initiates recording of the content corresponding to the broadcast media program from the receiver arrangement to the storage element in accordance with a broadcast schedule and automatically extends recording of the content received from the broadcast channel via the receiver arrangement for a duration of time beyond an end time for the broadcast media program specified by the broadcast schedule in response to an indication to extend recording of the broadcast media program that is received via the distribution network.

Various embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram of a media system including a media device for recording broadcast media content in accordance with one or more embodiments;

FIG. 2 is a block diagram of a media device suitable for use in the media system of FIG. 1 in accordance with one or more embodiments; and

FIG. 3 is a flowchart of an exemplary recording management process suitable for use with the media device of FIG. 1 or the media device of FIG. 2 in accordance with one or more embodiments.

### DETAILED DESCRIPTION

The following detailed description of the invention is merely exemplary in nature and is not intended to limit the invention or the application and uses of the invention. Furthermore, there is no intention to be bound by any theory presented in the preceding background, brief summary, or the following detailed description.

Embodiments of the subject matter described herein generally relate to adjusting a timer used to record a particular instance of broadcast media content in real-time. As used herein, “media content,” “media program,” or variants thereof should be understood as referring to any audiovisual programming or content in any streaming, file-based or other format, with “audio portion” or “audio content” referring to the audio component of the media content and “video portion” or “video content” referring to the video component of the media content.

In exemplary embodiments described herein, a media device receives audiovisual content for a broadcast media program that is initially scheduled for recording in accordance with a broadcast schedule from a network (e.g., a satellite distribution network, a cable distribution network, or the like). The media device receives an indication to adjust a recording timer associated with the scheduled recording of the broadcast media program via the network, and in response, the media device automatically adjusts the recording timer associated with the broadcast media program so that the recording schedule for the broadcast media program deviates from the original broadcast schedule and automatically records the broadcast media program in accordance with the adjusted recording timer.

For example, the duration of a live event may deviate from the originally scheduled airtime or duration for the broadcast of that event, and accordingly, an indication to adjust the recording timer associated with a broadcast media program may be provided to account for the broadcast of the live event deviating from the broadcast schedule. The media device may receive an indication to extend the current recording of the broadcast media program corresponding to the live event, and in response, automatically adjust the scheduled recording end time associated with the broadcast media program to extend for a duration of time beyond a scheduled recording end time originally specified by the broadcast schedule. Thereafter, the media device continues or otherwise maintains receiving audiovisual content from the broadcast channel associated with the broadcast media program and recording the received audiovisual content until reaching the adjusted recording end time. Similarly, an indication to terminate a current recording or an indication to advance or delay one or more recording timers associated with a scheduled recording of broadcast media program yet to be aired may be received, and in response, the media device automatically adjusts the recording timers with the identified broadcast media program and records the identified broadcast media program in accordance with the adjusted recording timer(s). As described in greater detail below, in response to the recording timers of a current or scheduled recording being adjusted, the recording schedule implemented by the media device may also be automatically updated or otherwise adjusted to reallocate resources of the media device according to the updated recording schedule.

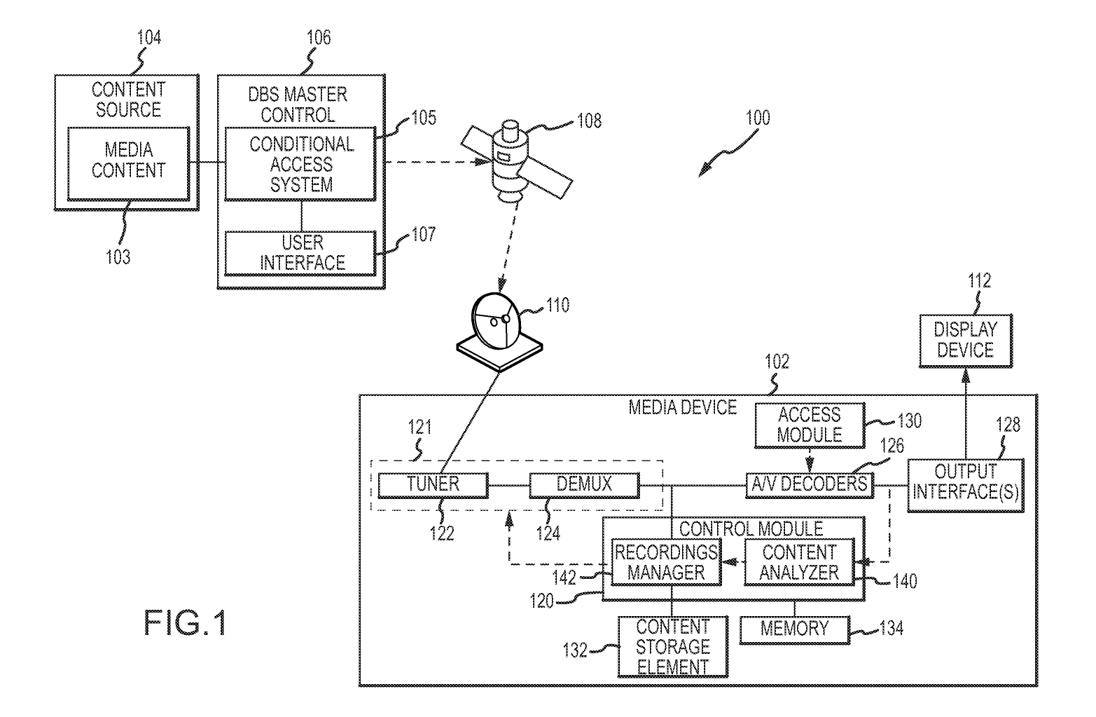

FIG. 1 depicts an exemplary media system 100 including a media device 102 capable of receiving and recording broadcast media content 103 originating from a content (or programming) source 104. In the illustrated embodiment, the content source 104 generates or otherwise provides the audiovisual media content 103 to a broadcast control system 106, which, in turn, formats the media content 103 for broadcast transmission to media devices via a distribution network 108. In exemplary embodiments described herein, the media device 102 records or otherwise copies a broadcast media program received via the distribution network 108 to a data storage element 132 of the media device 102 in accordance with a broadcast schedule. As described in greater detail below, the media device 102 automatically adjusts one or more timers associated with the recording in real-time in response to receiving a corresponding recording adjustment indication associated with that broadcast media program that is received via the distribution network 108.

The illustrated broadcast control system 106 generally represents the master control or other ground station associated with the distribution network 108. In exemplary embodiments described herein, the broadcast control system 106 is realized as a digital broadcast satellite (DBS) master control station that includes a real-time encoding system 105 configured to receive the audiovisual media content 103 from the broadcast source 104 and encode or otherwise convert the audiovisual media content 103 into packets which are then broadcast over-the-air via the satellite distribution network 108. In the illustrated embodiment, the broadcast control system 106 includes one or more user interface elements 107 that may be utilized by personnel at the master control station to identify or otherwise indicate, to the real-time encoding system 105, a broadcast media program for which a recording timer should be adjusted, and additionally in some embodiments, the manner in which the recording timer should be adjusted (e.g., advanced or delayed). In response to receiving the user input indicative of a particular broadcast media program requiring a recording timer adjustment, the real-time encoding system 105 generates or otherwise provides a corresponding recording adjustment indication that is inserted within a transmission stream provided to the distribution network 108 and broadcast to media devices 102 within the media system 100 that are recording (or scheduled to record0 that broadcast media program.

In the embodiment of FIG. 1, the indication is realized as a metadata tag or other piece of data that is associated with the audiovisual content of the identified broadcast media program and includes one or more bits or fields that identifies the manner in which the recording timer should be adjusted. In this regard, the recording adjustment indication may be embedded within the audio content of the identified broadcast media program, for example, within a field or bit of an ID3 tag, or alternatively, within the video content of the identified broadcast media program, for example, within the closed-captioning portion of the video content stream. Thus, the media device 102 recording that broadcast media program may detect or otherwise identify the recording adjustment indication within the audio or video content corresponding to the broadcast media program being recorded, and in response, automatically adjust a recording timer associated with the broadcast media program in the indicated manner.

The media device 102 generally represents an electronic device, hardware, or other component capable of receiving and processing broadcast audiovisual content from a distribution network 108 and providing media content to a display device 112 for presentation thereon. In this regard, the display device 112 generally represents a television, monitor, liquid crystal display (LCD), light emitting diode (LED) display, plasma display, or the like that graphically presents, renders, or otherwise displays imagery and/or video corresponding to media content provided by the media device 102. The display device 112 may also generate sound or otherwise reproduce the audio corresponding to the audio portion of the media content provided to the display device 112. In exemplary embodiments, the media device 102 is a set-top box (STB) or similar system that is able to receive broadcast television programming and/or to record certain broadcast media programs. Exemplary embodiments of media device 102 will therefore include a receiver arrangement 121 for receiving satellite, cable and/or broadcast programming signals from the distribution network 108, as well as a data storage element 132 to support a digital video recorder (DVR) feature and/or functionality, and a display interface 128 for providing imagery and/or video corresponding to a media program to the display device 112. For convenience, but without limitation, the content storage element 132 may alternatively be referred to herein as a DVR. The content storage element 132 stores recorded programming (e.g., broadcast media programs received via tuner 122) on a hard disk drive, memory, or other suitable non-volatile storage medium as appropriate in response to user/viewer programming instructions. Media program content in the content storage element 132 may be stored in any sort of compressed or uncompressed format, as desired, and may be encoded or transcoded as desired for effective receipt, storage, retrieval and playing.

It should be appreciated that FIG. 1 depicts merely one exemplary embodiment of a media device 102, and in practice, the media device 102 may be physically and/or logically implemented in any manner to suit the needs of a particular embodiment. In this regard, in some embodiments, the components in media device 102 may be provided within a common chassis or housing as illustrated in FIG. 1, although equivalent embodiments may implement media device 102 with any number of inter-connected but discrete components or systems. For example, in some embodiments, the media device 102 may be realized as a combination of a STB and a placeshifting device, wherein some features of the media device 102 are implemented by the STB and other features of the media device 102 are implemented by the placeshifting device, wherein the placeshifting device works in conjunction with the STB to shift the viewing experience from a home television (e.g., display device 112) to another display that is accessed via communications network (e.g., the internet).

In the illustrated embodiment, media device 102 is capable of receiving DBS signals transmitted from the DBS master control 106 via the satellite distribution network 108 using an antenna 110 that provides received signals to a tuner 122. In such embodiments, the media device 102 may also include an access module 130, such as a card interface or card reader adapted to receive a smart card or the like, which is configured to ensure that the viewer is authorized to view media content received from the distribution network 108. In this regard, the access module 130 may include unique identification information associated with a particular subscriber to the distribution network 108 or otherwise include authorization (or subscription) information that facilitates receiving and/or decoding media content received from the distribution network 108. Equivalent embodiments, however, could receive programming from any sort of cable connection, broadcast source, removable media, network service, external device and/or the like. It should be appreciated, however, that the subject matter described herein is not necessarily limited to implementation or use with media devices including such an access module.

The output of the tuner 122 is provided to a demultiplexing arrangement (or demultiplexer) 124 that separates the packetized transmission streams within the received DBS signals into individual audio and video content streams corresponding to the broadcast media program being recorded to the content storage element 132 and/or viewed on the display device 112. For example, a demultiplexer 124 may use a program-specific information (PSI) table (which may be previously received from the broadcast control system 106 via the distribution network 108) to identify the program identifier(s) associated with the broadcast media program (or broadcast channel) to be recorded, select or otherwise identify packets including the identified program identifier(s) from the multiplexed transmission stream received via the tuner 122, and output the selected packets.

A decoding arrangement (or decoder) 126 of the media device 102 is coupled to the output of the demultiplexer 124 to decode or otherwise convert the digital broadcast media content from the demultiplexer 124 into corresponding signals provided to the output interface(s) 128 of the media device 102 for reproduction to a viewer. As illustrated, the decoder 126 may be coupled to the access module 130 to receive authorization information or subscription information utilized to descramble or otherwise decrypt the audiovisual content in accordance with the access rights of a particular subscriber associated with the media device 102. The decoder 126 includes a video decoder to convert video packets from the demultiplexer 124 into video signals representative of the imagery for the video portion of a media program, which, in turn, is provided to a display interface 128 for reproducing the imagery on the display device 112. Similarly, the decoder 126 includes an audio decoder to convert audio packets from the demultiplexer 124 into audio signals representative of the audio portion of the media program, which, in turn, is provided to an audio output interface 128. It should be appreciated that in embodiments where the display device 112 is also utilized for audio reproduction, the audio signals output by the audio decoder may be provided to the display device 112 in conjunction with the video signals output by the video decoder via a common interface 128.

Still referring to FIG. 1, the media device 102 includes a control module 120 configured to direct, manage, or otherwise control the operations of the media device 102 and support the tasks, operations, functions and/or processes described herein. The control module 120 may be realized as any suitable processing system, processing device, hardware, firmware, and/or other components or combinations thereof. For example, the control module 120 may include one or more processors, central processing units (CPUs), graphics processing units (GPUs), controllers, microprocessors, microcontrollers, processing cores and/or other computing resources configured to support the subject matter described herein. The media device 102 also includes a data storage element (or memory) 134 that is coupled to or otherwise accessed by the control module 120. The memory 134 may be realized using as random access memory (RAM), read only memory (ROM), flash memory, magnetic or optical mass storage, or any other suitable configuration of non-transitory short or long term data storage or other non-transitory computer-readable media capable of storing programming instructions for execution by the control module 120. The stored programming instructions, when read and executed by the control module 120, cause the control module 120 to perform various tasks, functions, and/or processes to control operations of the media device 102 and support the subject matter described herein. In some embodiments, the control module 120 is implemented as a “system on a chip” (SoC) that incorporates a hybrid microcontroller with memory, input/output and other features to perform the various processing and other functionality of media device 102, and in which case a separate memory 134 may not be provided.

In the illustrated embodiment of FIG. 1, application code is stored or otherwise maintained in the memory 134 and executed by the control module 120 to implement or otherwise provide a content analysis application 140 (or content analyzer) that monitors or otherwise analyzes the decoded output from the decoder 126 to detect or otherwise identify recording adjustment indications within the decoded media content. For example, in embodiments where the recording adjustment indication is embedded within the audio content, the content analyzer 140 monitors the decoded audio portion of the broadcast media program to detect the recording adjustment indication within the broadcast media program audio content. Similarly, in embodiments where the recording adjustment indication is embedded within the video content, the content analyzer 140 monitors the decoded video portion of the broadcast media program to detect the recording adjustment indication within the broadcast media program video content.

Additionally, the control module 120 executes application code to implement or otherwise provide a recording management application 142 (or recordings manager) that facilitates storing or recording of media content output from the demultiplexer 124 to the content storage element 132 in accordance with a user-defined recording schedule. In this regard, a user may manipulate a user input device associated with the media device 102 (e.g., a remote control or the like) to interact with a sequence of graphical user interface (GUI) menu displays presented on the display device 112 to select or otherwise identify broadcast media programs that the user would like to record. Additionally, in embodiments where the media device 102 is equipped with multiple instances of the tuner 122 and the demultiplexer 124 to support simultaneous or concurrent recordings of multiple different broadcast media programs on different broadcast channels, the user may also interact with the media device 102 to set or otherwise define priorities for the various media programs scheduled for recording, as well as provide other criteria for resolving conflicts between scheduled recordings.

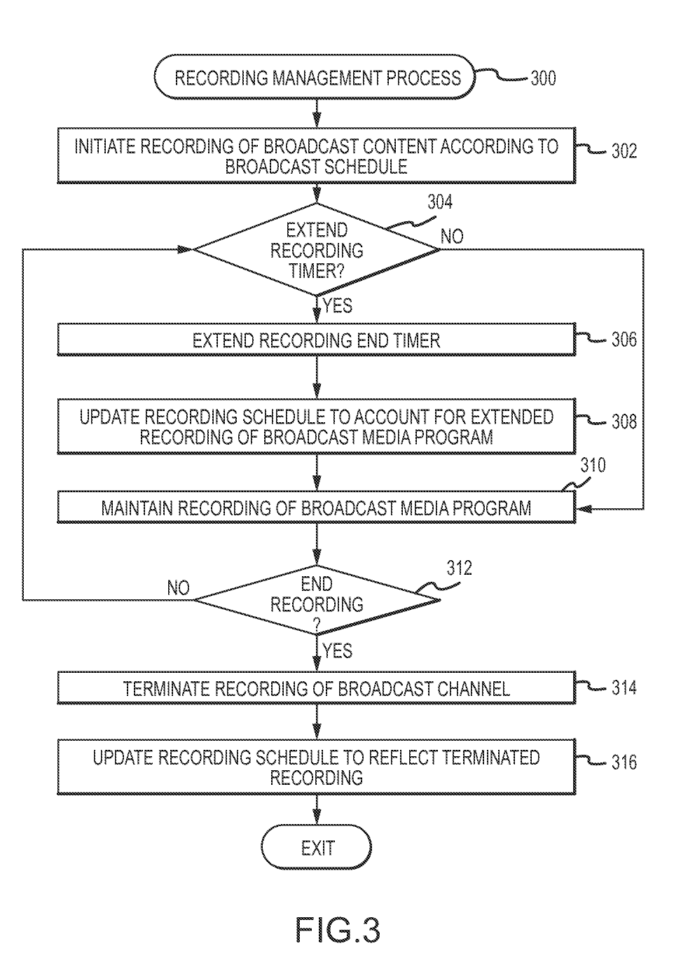

As described in greater detail below in the context of FIG. 3, the content analyzer 140 communicates or otherwise interacts with the recordings manager 142 to provide recording adjustment indications detected within the decoded audiovisual content of a media program currently being recorded by the recordings manager 142, and in response to receiving the indication, the recordings manager 142 automatically adjusts one or more recording timers. For example, the recordings manager 142 may delay or otherwise increase the recording end time for the broadcast media program to extend recording of the broadcast media program for a duration of time beyond an initial end time that was originally specified by the broadcast schedule. To support the extended recording, the recordings manager 142 maintains configuration of the tuner 122 to receive the broadcast media program currently being recorded for the extended duration, maintains configuration of the demultiplexer 124 to output the broadcast media content on the broadcast channel corresponding to the media program being recorded, and copies, transfers, or otherwise records the received audiovisual content output from the demultiplexer 124 for the extended duration of time. Additionally, the recordings manager 142 may automatically adjust one or more recording timers for other broadcast media programs that are scheduled to be recorded. For example, if the broadcast media program following the currently recording media program on the same broadcast channel is also scheduled for recording, the recordings manager 142 may delay its recording start timer and/or its recording end timer by an amount corresponding to the extended recording duration for the preceding broadcast media program on that same broadcast channel.

After adjusting the recording timers in response to the recording adjustment indication from the content analyzer 140, the recordings manager 142 may automatically update the recording schedule based on the updated recording timers for the broadcast media program(s) and the user-defined recording priorities and/or recording conflict-resolution criteria. In this regard, recordings of one or more broadcast media programs may be canceled based on the extended recording duration resulting in the tuner 122 and the demultiplexer 124 being unavailable for that broadcast media program. Additionally, recordings of one or more broadcast media programs may be added to the recording schedule based on the cancellation of recording(s) of other broadcast media program(s) resulting from the extended duration of a current recording.

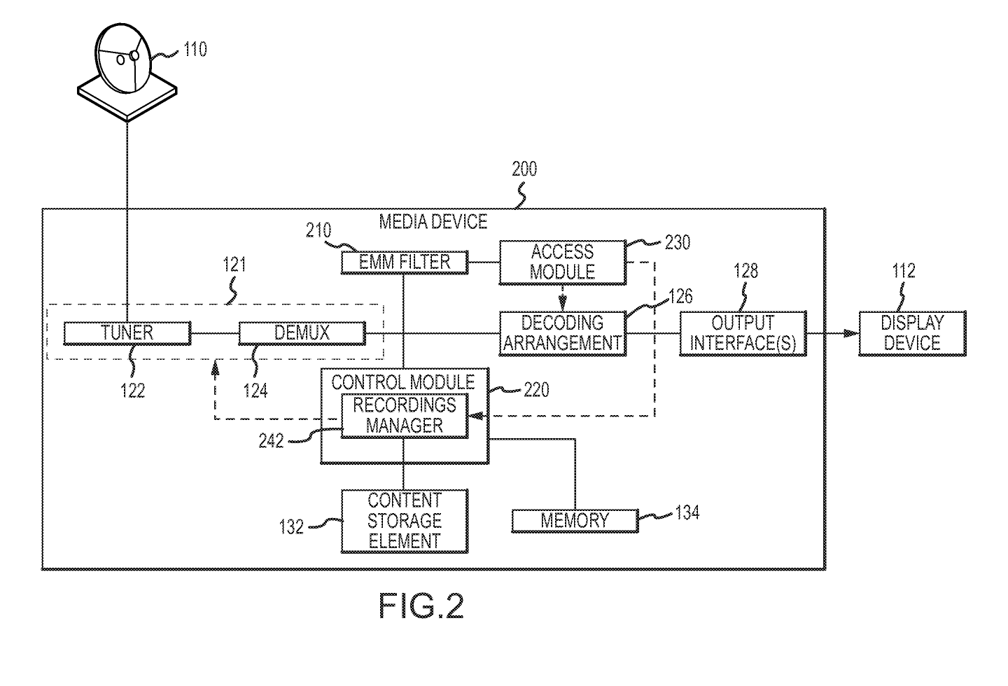

FIG. 2 depicts another embodiment of a media device 200 suitable for use in the media system 100 of FIG. 1. The various elements or components of the media device 200 are similar to counterpart elements or components described above in the context of the media device 102 of FIG. 1, and accordingly, such common features or functionality will not be redundantly described here in the context of FIG. 2.

The media device 200 includes an entitlement management message (EMM) filter 210 that is coupled to the output of the demultiplexer 124 to detect or otherwise identify EMMs within the received transmission stream(s) that correspond to the media device 200. In this regard, the EMM filter 210 identifies or otherwise detects an EMM that identifies the media device 200 as an intended recipient for the message, for example, by virtue of the EMM including a unique identifier associated with the media device 200 within an EMM packet header or including a global address in the EMM packet header. In this regard, a conditional access system associated with the broadcast control system 106 may generate or otherwise provide EMMs that are inserted in the transmission stream(s) that are broadcast via the distribution network 108 and detected or otherwise identified by the demultiplexer 124, which, in turn, provides the EMMs to the EMM filter 210 for further analysis. When the EMM filter 210 detects or otherwise identifies an EMM that pertains to the media device 200, the EMM filter 210 provides the payload of the EMM to the access module 230 for further processing. It should be noted that although the EMM filter 210 is not illustrated in the media device 102 of FIG. 1, in practice, the media device 102 may also include an EMM filter 210 that supports receiving and handling EMMs in an equivalent manner.

In the embodiment of FIG. 2, the recording adjustment indication is provided to the media device 200 via an EMM that identifies the broadcast media program for which a recording timer should be adjusted. For example, a globally-addressed EMM may include, in its payload, a unique program identifier associated with the broadcast media program requiring a recording time adjustment, a broadcast channel number or other broadcast channel identifier associated with the media program requiring a recording time adjustment, or some other metadata (e.g., a program title, description, or the like) that identifies the broadcast media program. The EMM packet payload may also include information identifying the manner and/or amount by which the recording timer(s) associated with the identified broadcast media program should be adjusted.

In the illustrated embodiment, the access module 230 descrambles, decrypts, or otherwise decodes the EMM payload received from the EMM filter 210 and provides the payload to the control module 220 and/or the recordings manager 242 for further processing. However, it should be noted that in other embodiments, the recording adjustment indication may be provided within an unencrypted or unprotected message, in which case, the payload of the received message may be provided directly to the control module 220 and/or the recordings manager 242 for further processing. Furthermore, the message containing the recording adjustment indication may be provided to the media device 200 via a network (e.g., the Internet or another communications network) that is different from the distribution network 108.

In response to receiving EMM payload that identifies a broadcast media program that is currently being recorded by the media device 200 (or alternatively, is scheduled to be recorded), the recordings manager 242 automatically adjusts one or more recording timers associated with the identified broadcast media program as indicated by the EMM payload in a similar manner as described above (e.g., delaying or advancing the recording end time, the recording start time, or the like). After adjusting the recording timers in response to the recording adjustment indication, the recordings manager 242 may also automatically update the recording schedule based on the updated recording timers in a similar manner as described above in the context of FIG. 1. It should be noted that although FIG. 2 depicts the EMM filter 210 receiving EMMs from the same receiver arrangement 121 used for the broadcast media program being recorded, in alternative embodiments, the EMM filter 210 may be configured to receive EMMs from a different receiver arrangement (e.g., a different tuner and/or demultiplexer) of the media device 200, such that the EMM including a recording time adjustment for the broadcast media program being recorded is broadcasted and/or received via a different broadcast channel on the distribution network 108.

FIG. 3 depicts an exemplary embodiment of a recording management process 300 for adjusting one or more recording timers being utilized by a media device 102, 200 recording a broadcast media program in real-time. The various tasks performed in connection with the illustrated process 300 may be implemented using hardware, firmware, software executed by processing circuitry, or any combination thereof. For illustrative purposes, the following description may refer to elements mentioned above in connection with FIGS. 1-2. In practice, portions of the recording management process 300 may be performed by different elements of a media system 100, such as, for example, the broadcast control system 106, the encoding system 105, the media device 102, 200, the media device control module 120, 220, the content analyzer 140 and/or the recordings manager 142, 242. It should be appreciated that the recording management process 300 may include any number of additional or alternative tasks, the tasks need not be performed in the illustrated order and/or the tasks may be performed concurrently, and/or the recording management process 300 may be incorporated into a more comprehensive procedure or process having additional functionality not described in detail herein. Moreover, one or more of the tasks shown and described in the context of FIG. 3 could be omitted from a practical embodiment of the recording management process 300 as long as the intended overall functionality remains intact.

The illustrated recording management process 300 begins by starting or otherwise initiating recording of a broadcast media program according to an original broadcast schedule (task 302). In this regard, based on the recording schedule maintained in memory 134, the recordings manager 142, 242 automatically initiates recording of a particular broadcast media program by configuring the receiver arrangement 121 to receive the broadcast channel associated with that broadcast media program at a recording start time based on the program start time specified by the broadcast schedule. Thereafter, the recordings manager 142, 242 transfers, copies, writes, or otherwise records the received audiovisual content stream on the broadcast channel associated with the broadcast media program to be recorded to the content storage element 132 until the recording end time associated with the broadcast media program is reached. In this regard, absent any adjustment, the recording end time associated with the broadcast media program initially corresponds to the scheduled end time for the broadcast media program (or alternatively, the sum of the scheduled start time for the broadcast media program and an offset corresponding to the scheduled airtime duration for the broadcast media program). In some embodiments, the initial recording start time and/or the initial recording end time may be automatically offset from the scheduled start time and/or the scheduled end time for the broadcast media program by an amount of time (which may be a fixed default amount of time, a user-specific or user-configurable amount of time, or the like) to provide a buffer before and/or after the scheduled airtime of the broadcast media program.

In exemplary embodiments, while the broadcast media program is being recorded, the recording management process 300 detects or otherwise identifies an indication to adjust the recording timer for the broadcast media program (task 304). In this regard, the media device 102, 200 recording a particular broadcast media program may determine the end time for the recording of that broadcast media program should be extended or delayed by detecting or otherwise identifying a corresponding recording adjustment indication within the broadcast content stream received from the distribution network 108. For example, when the broadcast media program being recorded corresponds to a live event being broadcast in real-time, and the duration of the live event extends (or is likely to extend) beyond the scheduled end time for the live event, the broadcast control system 106 transmits or otherwise provides an indication, to media devices recording that broadcast media program, to extend the end recording time associated with the broadcast media program to account for the extended duration of the live event. In one or more embodiments, a user at the DBS master control 106 monitors the live event and manipulates the user interface element 107 to identify or otherwise indicate the corresponding broadcast media program having an end time that should be extended. In other embodiments, the broadcast control system 106 may receive the indication of the broadcast media program to be extended from an external device or system via a communications network (e.g., from a remote server via the internet). In yet other embodiments, the broadcast control system 106 may implement one or more algorithms to continuously monitor broadcast media programs in real-time and automatically detect or identify a broadcast media program to be extended (e.g., by monitoring excitement ratings, scores, game time remaining, or the like associated with sporting events at or near their scheduled end time).

In response to identifying a broadcast media program having an end time that should be extended, the encoding system 105 generates or otherwise creates a recording adjustment indication associated with the broadcast media program that is transmitted or otherwise broadcast over the distribution network 108. In one or more embodiments, the encoding system 105 generates a metadata tag associated with the audiovisual content of the broadcast media program that includes data that identifies that the end time of the broadcast media program should be delayed or otherwise extended. For example, the encoding system 105 may generate an ID3 tag that is embedded or otherwise inserted into the encoded audio portion of the broadcast media program that indicates the duration of the broadcast media program exceeds the original duration specified by the broadcast schedule. In such embodiments, the content analyzer 140 of the control module 120 detects or otherwise identifies that the recording end time associated with the broadcast media program being recorded and received using the tuner 122 should be extended in response to detecting the recording extension indication within the decoded audio content output by the audio decoder 126. Additionally or alternatively, the encoding system 105 may generate metadata that is embedded or otherwise inserted into the closed-captioning portion of the video content stream for the broadcast media program, with that closed-captioning metadata indicating the actual duration of the broadcast media program exceeds the original duration specified by the broadcast schedule. In such embodiments, the content analyzer 140 of the control module 120 detects or otherwise identifies that the recording end time associated with the broadcast media program being recorded and received using the tuner 122 should be extended in response to detecting the recording extension indication within the closed-captioning portion of the decoded video content output by the video decoder 126.

In other embodiments, the broadcast control system 106 generates an EMM (or similar message) that identifies the broadcast media program to be extended. For example, as described above, a conditional access system associated with the DBS master control 106 may generate an EMM packet including a global address in the packet header and an identification of the broadcast media program to be extended within the payload of the EMM packet. Thereafter, the broadcast control system 106 transmits or otherwise broadcasts the message via the distribution network 108. As described above in the context of FIG. 2, the recordings manager 242 of the control module 220 detects or otherwise identifies the indication to extend the recording of the broadcast media program associated with the current configuration of the tuner 122 and the demultiplexer 124 via the EMM filter 210 and the access module 230.

Referring to FIG. 3, in exemplary embodiments, in response to an indication to extend the recording timer for a broadcast media program, the recording management process 300 extends the recording duration by delaying the recording end time being implemented by the media device (task 306). In exemplary embodiments, the recording end time is not extended indefinitely to conserve resources and reduce the likelihood of memory overrun, while also allowing for the recording schedule to be updated in accordance with the recording priorities and conflict-resolution criteria maintained by the recordings manager 142, 242 (e.g., in memory 134). In one or more embodiments, the recording end time is delayed or extended by a fixed amount (e.g., 30 minutes), which could be a default adjustment amount that the media device 102, 200 is preconfigured to implement, or a user-specified adjustment amount that is specific to the particular media device 102, 200. For example, a user may manipulate a remote control or other user input device associated with the media device 102, 200 to specify the amount that the user would like to allow recordings to be extended. In other embodiments, the fixed amount may be set by the broadcast control system 106 and embedded or otherwise associated with the recording adjustment indication that is transmitted over the distribution network 108. In other embodiments, the recording end time may be set to a specific time in the future. For example, the recording end time may be set to the time of the next broadcast schedule increment (e.g., the next 30-minute increment, 5-minute increment, 1-minute increment, or the like).

In some embodiments, the amount by which the recording end time is delayed or extended is calculated or otherwise determined in real-time. In this regard, the recording adjustment may correspond to the originally scheduled program airtime (or duration), so that the recording timer adjustments for media programs having longer originally-scheduled airtimes are greater than the adjustments that would be made for the recording timer(s) for a media program having a shorter scheduled airtime. In one embodiment, the fixed amount for delaying the recording end time may be specified as a percentage of the originally scheduled duration for the media program according to the broadcast schedule, where the recordings manager 142, 242, the control module 120, 220 and/or the broadcast control system 106 calculates or otherwise determines the amount of time corresponding to that percentage of the originally scheduled program duration. For example, if a user-specified recording adjustment amount maintained by the media device 102, 200 is set to 25% of the originally scheduled program duration, in response to a recording adjustment indication for a broadcast media program having an originally scheduled airtime of three hours, the recordings manager 142, 242 may automatically determine that the recording end time for that broadcast media program should be extended by forty-five minutes. In yet other embodiments, additional recording adjustment criteria may be utilized to dynamically determine the recording adjustment amount for broadcast media programs. For example, the recordings manager 142, 242 may automatically determine the recording adjustment amount based on the number of available tuners 122 and/or demultiplexers 124 for the media device 102, 200, the number of concurrent broadcast media programs that are currently recording and/or scheduled for recording, the amount of space available on the content storage element 132, and the like. In this regard, the amount by which the recording end time is delayed or extended may be based on the resources of the media device 102, 200 that are currently being consumed or likely to be consumed during the extended recording duration (or alternatively, the available resources during the extended recording duration).

After extending the recording timer for the broadcast media program being recorded, the recording management process 300 continues by updating the current recording schedule to account for the extended recording duration (task 308). In this regard, once the recording end time is adjusted, the recordings manager 142, 242 automatically updates the recording schedule to reflect the receiver arrangement 121 being allocated to the currently recording broadcast media program for an extended duration beyond the originally scheduled recording end time. In this regard, when the extended allocation of the receiver arrangement 121 result in a number of recordings scheduled to begin during the extended recording duration that exceeds the number of available tuners or receivers onboard the media device 102, 200, the recordings manager 142, 242 automatically cancels one or more of those scheduled recordings based on the recording priority list and/or other recording conflict-resolution criteria maintained by the media device 102, 200. It should be noted that in some embodiments, the recordings manager 142, 242 automatically updates the recording schedule by first delaying the recording start time and/or the recording end time for a scheduled recording that follows the currently recording broadcast media program that was extended on the same broadcast channel to account for the preceding broadcast media program overrunning its initially scheduled end time before updating the recording schedule in a manner that reflects both the extended recorded duration of the broadcast media program currently being recorded as well as the likely delay in the airing of the broadcast media program that follows on that broadcast channel.

Still referring to FIG. 3, the recording management process 300 maintains the recording of the broadcast media program beyond the originally scheduled recording end time according to the extended recording end time until identifying or otherwise determining that the recording should be terminated (tasks 310, 312). In this regard, the recordings manager 142, 242 maintains the current configuration of the tuner 122 and demultiplexer 124 for receiving the broadcast media program currently being recorded and continues transferring, writing, copying, or otherwise storing the audiovisual content output by the demultiplexer 124 for that broadcast channel to the content storage element 132 until the current time corresponds to the recording end time for the broadcast media program.

In some embodiments, the recordings manager 142, 242 determines to terminate the recording of the broadcast media program in response to receiving a subsequent recording adjustment indication for the broadcast media program that indicates that the recording should end or that the recording end time should be advanced to the current time. In a similar manner as described above with respect to extending the recording time, the broadcast control system 106 may identify or otherwise determine that the recording of a broadcast media program should be terminated (e.g., in response to user input via the user interface element 107, an indication from an external device or system via a communications network, or the like), and in response, the encoding system 105 transmits or otherwise provides, via the distribution network 108, a corresponding recording adjustment indication that identifies the broadcast media program whose recording timer should be terminated. In this regard, the loop defined by tasks 304, 306, 308, 310 and 312 may repeat throughout the duration of a broadcast media program to dynamically adjust the recording end time for the broadcast media program as needed in real-time. Thus, the recording end time for the broadcast of a live event may be incrementally extended as needed to account for the actual duration of the live event and then set to the current time (or some other time preceding the extended recording end time) to terminate the recording once the live event is over.

For example, if the broadcast media program corresponds to a live sporting event, the DBS master control 106 may receive a user input or otherwise determine that the live sporting event is going into overtime or will otherwise overrun the initially scheduled air time for the event. In response, the encoding system 105 transmits or otherwise provides a recording adjustment indication via the distribution network 108 that identifies, to instances of the media device 102, 200 recording the broadcast of that sporting event, that the recording end time should be extended beyond the originally scheduled end time of the sporting event. In some situations, the DBS master control 106 may receive a user input or otherwise determine that the live sporting event will overrun the extended recording time (i.e., by exceeding the initially scheduled airtime for the event by more than the amount by which the recording end time was extended), and in response, transmit or otherwise provide another recording adjustment indication via the distribution network 108 that identifies, to instances of the media device 102, 200 recording the broadcast of that sporting event, that the recording end time should be further extended. Thereafter, the DBS master control 106 may receive a user input or otherwise determine that the live sporting event has ended, and in response, transmit or otherwise provide another recording adjustment indication via the distribution network 108 that identifies, to instances of the media device 102, 200 recording the broadcast of that sporting event, that the recording should be terminated (e.g., by setting the recording end time to the current time).

Referring again to FIG. 3, after determining the recording should be terminated, the recording management process 300 terminates the recording of the broadcast channel associated with the broadcast media program and automatically updates the recording schedule of the media device to account for the previously extended recording being terminated (tasks 314, 316). In this regard, when the current time corresponds to the recording end time for the broadcast media program, the recordings manager 142, 242 automatically stops transferring or writing audiovisual content from the broadcast channel associated with the broadcast media program to the file in the content storage element 132 that corresponds to the broadcast media program that was being recorded. Thereafter, the recordings manager 142, 242 automatically updates the recording schedule to reflect that the receiver arrangement 121 is no longer allocated to the broadcast media program that was previously being recorded. In this regard, the recordings manager 142, 242 may reallocate the receiver arrangement 121 to another broadcast media program that is scheduled to be recorded in accordance with the recording priority list and/or other recording conflict-resolution criteria implemented by the recordings manager 142, 242. Thereafter, the recording management process 300 is repeated, so that at or before the recording start time for that broadcast media program, the recordings manager 142, 242 automatically reconfigures the receiver arrangement 121 to receive a broadcast channel associated with that broadcast media program and automatically transfers, writes, or otherwise copies the audiovisual content output from the demultiplexer 124 to the content storage element 132 at the recording start time (e.g., task 302). Thereafter, the recording end time for that broadcast media program may be dynamically adjusted as needed in real-time, as described above.

It should be noted that although the subject matter is described herein primarily in the context of extending or delaying the recording end time of a broadcast media program that is currently in the process of being recorded, the subject matter is not necessarily limited to such an implementation. The subject matter described above may be implemented in an equivalent manner to advance the recording end time for broadcast media programs, for example, for broadcasts of live events that end before their initially scheduled end time. For example, the content analyzer 140 may detect the start of a broadcast media program scheduled for recording within the audio and/or video portion of the media content aired on the broadcast channel associated with the broadcast media program to be recorded, or the recordings manager 242 may identify a received message that identifies that recording of a particular broadcast media program scheduled for recording should be automatically initiated at the current time. Thus, an EMM or other broadcasted message may be utilized to adjust the recording start time for scheduled recordings of broadcast media programs that have not yet aired (either on the same or different broadcast channel than the media device 102, 200 is tuned to), or to adjust the recording times associated with other broadcast media programs that are influenced by the duration of a live event that is aired on a different broadcast channel (e.g., postgame shows for sporting events). In this regard, to the extent that the extended duration of a broadcast media program affects the start time, end time, and/or duration of other broadcast media programs on other broadcast channels and results in deviations from the original broadcast schedule across multiple different broadcast channels, EMMs identifying the impacted broadcast media programs and the appropriate adjustments to the recording start time and/or end time for those impacted broadcast media programs may be transmitted via the distribution network 108.

To briefly summarize, the user experience is enhanced by adjusting recording timers in real-time to account for real-time deviations in the airtime of broadcast media programs from the original broadcast schedule, thereby allowing for the entirety of the broadcast media program content to be recorded in situations where the actual airing of the broadcast media program does not align or otherwise match the original broadcast schedule. In particular, recordings of broadcasts of live events that run long need not be truncated or cut short (assuming available disk space for storage), so that users are not frustrated when the ending of the live event is not recorded. Moreover, the amount by which recordings are extended or adjusted may be manually configured, which, in conjunction with user-specified recording priorities and/or other recording conflict-resolution criteria ensures that broadcast media programs are recorded in a manner that is both predictable and satisfactory to the user.

The general systems, structures and techniques described above may be inter-combined, enhanced, modified and/or otherwise implemented to provide any number of different features. In particular, the term “exemplary” is used herein to represent one example, instance or illustration that may have any number of alternates. Any implementation described herein as “exemplary” should not necessarily be construed as preferred or advantageous over other implementations.

For the sake of brevity, conventional techniques related to broadcasting, distribution, encoding/decoding, encrypting/decrypting, multiplexing/demultiplexing, programming schedules, recording schedules, digital video recorders (DVRs), set-top boxes (STBs), satellite transmission and reception, metadata tags, closed-captioning data, audio reproduction, video reproduction, content formats, file structures, buffering, and other functional aspects of the systems (and the individual operating components of the systems) may not be described in detail herein. The subject matter may be described herein in terms of functional and/or logical block components, and with reference to symbolic representations of operations, processing tasks, and functions that may be performed by various computing components or devices. It should be appreciated that in alternative embodiments the various block components shown in the figures may be equivalently realized by any number of components configured to perform the specified functions. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter. In addition, certain terminology may also be used herein for the purpose of reference only, and thus is not intended to be limiting. For example, terms such as “first,” “second” and other such numerical terms referring to structures do not imply a sequence or order unless clearly indicated by the context.

While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents. Accordingly, details of the exemplary embodiments or other limitations described above should not be read into the claims absent a clear intention to the contrary.

1. A method of recording a broadcast media program using a media device receiving audiovisual content for the broadcast media program from a network, the method comprising:
receiving, by the media device via the network, an indication to extend a recording timer associated with the broadcast media program scheduled for recording in accordance with a broadcast schedule; and
in response to the indication:
automatically adjusting a recording end time associated with the broadcast media program to extend for a duration of time beyond an end time specified by the broadcast schedule; and
automatically recording the audiovisual content in accordance with the adjusted recording timer, wherein the automatically recording the audiovisual content comprises:
maintaining configuration of the media device to receive the broadcast media program from the network until the adjusted recording end time; and
recording the audiovisual content until the adjusted recording end time.

2. (canceled)

3. The method of claim 1, further comprising receiving a second indication to terminate recording of the broadcast media program, wherein:
automatically adjusting the recording timer associated with the broadcast media program comprises automatically setting the recording end time associated with the broadcast media program to a second time preceding a previous recording end time; and
automatically recording the audiovisual content in accordance with the adjusted recording timer comprises automatically terminating the recording of the audiovisual content at the second time.

4. The method of claim 1, further comprising detecting, by the media device, the indication within the audiovisual content of the broadcast media program.

5. The method of claim 4, wherein detecting the indication comprises:
analyzing metadata tags associated with the broadcast media program; and
detecting the indication based on a field of a tag of the metadata tags.

6. The method of claim 4, the audiovisual content including video content, wherein detecting the indication comprises detecting the indication within closed-captioning data of the video content.

7. The method of claim 4, the audiovisual content including audio content, wherein detecting the indication comprises detecting the indication embedded within the audio content.

8. The method of claim 1, wherein receiving the indication comprises receiving a message identifying the broadcast media program and indicating the adjustment to the recording timer.

9. A method of recording content corresponding to a broadcast media program using a media device including a receiver arrangement configured to receive the content from a distribution network, the method comprising:
initiating recording of the content corresponding to the broadcast media program from the receiver arrangement to a storage element of the media device in accordance with a broadcast schedule;
receiving, by the media device via the distribution network, an indication to extend recording of the broadcast media program; and
in response to the indication, extending the recording of the content received via the receiver arrangement for a duration of time beyond an end time for the broadcast media program specified by the broadcast schedule.

10. The method of claim 9, wherein extending the recording comprises:
maintaining configuration of the receiver arrangement to receive the content from a broadcast channel of the distribution network associated with the broadcast media program for the duration of time; and
recording the content received from the broadcast channel to the storage element for the duration of time.

11. The method of claim 9, further comprising:
receiving, by the media device via the distribution network, a second indication to terminate recording of the broadcast media program during the duration of time while recording the broadcast media program; and
in response to the second indication, automatically terminating the recording of the content.

12. The method of claim 9, further comprising:
analyzing, by the media device, a metadata tag associated with the content; and
detecting the indication based on the metadata tag.

13. The method of claim 12, wherein analyzing the metadata tag comprises analyzing an ID3 tag within an audio portion of the content.

14. The method of claim 9, further comprising:
decoding, by the media device, the content received via the receiver arrangement into decoded media content; and
detecting the indication within the decoded media content.

15. The method of claim 14, wherein detecting the indication within the decoded media content comprises detecting the indication within closed-captioning data of a video portion of the decoded media content.

16. The method of claim 9, wherein receiving the indication comprises detecting a global entitlement management message identifying the broadcast media program.

17. A media device comprising:
a receiver arrangement to receive content corresponding to a broadcast media program from a broadcast channel of a distribution network;
a storage element; and
a control module coupled to the receiver arrangement and the storage element to:
initiate recording of the content corresponding to the broadcast media program from the receiver arrangement to the storage element in accordance with a broadcast schedule; and
automatically extend recording of the content received from the broadcast channel via the receiver arrangement for a duration of time beyond an end time for the broadcast media program specified by the broadcast schedule in response to an indication to extend recording of the broadcast media program received via the distribution network.

18. The media device of claim 17, further comprising a decoding arrangement to decode the content received via the receiver arrangement into decoded media content, wherein the control module is coupled to the decoding arrangement to detect the indication within the decoded media content.

19. The media device of claim 18, further comprising an access module coupled to the decoding arrangement to provide authorization information for a subscriber associated with the media device, wherein the decoding arrangement decodes the content in accordance with the authorization information.

20. The media device of claim 17, further comprising a message filtering module to detect messages intended for the media device received from the distribution network, wherein the control module is coupled to the message filtering module to detect the indication within a message identifying the broadcast media program.

21. The method of claim 1, further comprising automatically updating a recording schedule based on the adjusted recording end time for the broadcast media program, wherein automatically updating the recording schedule comprises automatically canceling one or more scheduled recordings.
